(19) United States
(12) Patent Application Publication
(10) Pub. No.: US 2021/0138709 A1
(43) Pub. Date: May 13, 2021

(54) MEASURING ARRANGEMENT FOR A SHAPING MACHINE

(71) Applicant: ENGEL AUSTRIA GmbH, Schwertberg (AT)

(72) Inventors: David MUEHLEHNER, Neumarkt (AT); Christoph BALKA, Schwertberg (AT)

(21) Appl. No.: 17/065,975

(22) Filed: Oct. 8, 2020

(30) Foreign Application Priority Data
Oct. 9, 2019 (AT) A 50860/2019

(51) Int. Cl. B29C 45/76; G01L 1/00; G01L 25/00

(52) U.S. Cl. CPC B29C 45/76; G01L 1/005; B29C 2945/7618; B29C 2945/76013; G01L 25/00

(57) ABSTRACT

A measuring arrangement for a shaping machine includes a measuring diaphragm deformable by a force action, a measuring device for metrological detection of a deformation of the measuring diaphragm with the output of a measurement signal, and an evaluation device connected to the measuring device. The evaluation device, in the course of a first calibration, can convert the measurement signal originating from the deformation of the measuring diaphragm with a force from a first force value range into a first output signal, and the first output signal is in a previously defined value range. The evaluation device, in the course of a second calibration, can convert the measurement signal originating from the deformation of the measuring diaphragm with a force from a second force value range differing from the first force value range into a second output signal, and the second output signal is in the previously defined value range.

### BACKGROUND OF THE INVENTION

The present invention concerns a measuring arrangement for a shaping machine, and a shaping machine having a measuring arrangement, as well as a method of providing a calibration of a measuring arrangement, and a computer program product for carrying out the individual steps of such a method.

It is already known that shaping machines are equipped with measuring arrangements which include a measuring diaphragm, a measuring device for detecting a deformation of the measuring diaphragm and a calibrated evaluation device connected to the measuring device.

In that case the measuring arrangements have been developed, designed and calibrated for a given range of force values. If that force range changes because of different loadings and/or machine designs then a specific measuring arrangement has to be developed, designed and calibrated for each range of force values or for each machine design configuration.

That can have the result that different measurement series have to be created for a shaping machine in order to be able to operate the injection assembly with different injection forces.

A disadvantage here is that a specific dedicated measuring arrangement has to be conceived for each shaping machine. That results in a large number of different measuring diaphragms, measuring devices and evaluation devices which have to be held in readiness by the producer.

The object of the invention is therefore to avoid the above-described disadvantages and to provide a unitary and thus less expensive solution in comparison with the state of the art.

### SUMMARY OF THE INVENTION

Therefore, in accordance with the invention, an evaluation device of the measuring arrangement includes:
a measuring diaphragm which is deformable by a force action,
a measuring device for metrological detection of a deformation of the measuring diaphragm with the output of a measurement signal, and
the evaluation device connected to the measuring device.

The evaluation device is adapted in the course of a first calibration to convert the measurement signal originating from the deformation of the measuring diaphragm with a force from a first force value range into a first output signal, wherein the first output signal is in a previously defined value range,

and in the course of at least one second calibration to convert the measurement signal originating from the deformation of the measuring diaphragm with a force from a second force value range differing from the first force value range into a second output signal, wherein the second output signal is in the previously defined value range.

The output value range is any range. It can be advantageous in that respect that calibration of the evaluation device is adapted to map the lower limit of a force value range to the lower limit of the previously defined output value range and the upper limit of a force value range to the upper limit of the previously defined output value range and the previously defined output value range is completely covered by the output values of the force value range. It has proven to be particularly advantageous in that respect for the lower limit of the output value range to be set at 0.

The evaluation device includes an amplifier adapted to amplify the signal by different amplification factors. That serves in particular to be able to map measurement signals of differing strengths to a unitary output value range.

According to a preferred embodiment, an evaluation device can switch over between the at least two calibrations.

The evaluation device can be adapted to alter the amplification factor of the amplifier upon switching over between the at least two calibrations. By virtue of a change in the amplification factor it can be provided that different force value ranges can be mapped on to a unitary output value range.

Particularly preferably, the evaluation device is adapted to control switching-over between the at least two calibrations by a signal of the central machine control means of a shaping machine.

By virtue of switching over between the at least two calibrations it is possible to use the measuring arrangement according to the invention in different machine types and/or machine sizes. It is also possible to operate a shaping machine with at least two different force ranges in respect of the injection assembly. That makes it possible to use materials involving different properties.

In an embodiment, a shaping machine is calibrated for two different force ranges. In that case both the force range of 0-250 kN and also the second force range of 0-150 kN can be mapped by different calibrations to the same value range (0-10V). That has the advantage that the resolution of the output signal is better for the second force range.

It is possible in that case for a calibration to be selected at any time by the machine control means even after it is set in operation. That permits inter alia more precise adaptation of the machine to an a priori known loading while making full use of the available output value range.

The evaluation device can have more than two calibrations. That has the effect that the measuring arrangement can be used for a plurality of different machine sizes and/or machine types without modifying the measuring device.

The evaluation device can be adapted to select the desired calibration by external control pulses, wherein the external control pulses differ by their time extent.

In accordance with an embodiment, the data transmission between the individual components of the measuring arrangement can be analog or digital (for example by a protocol like for example OPC-UA, EtherCAT or generally a field bus protocol and so forth).

To enhance the flexibility of the measuring arrangement, the memory unit of the evaluation device can be arranged at the measuring diaphragm. That permits a modular structure in which the calibration operations matching the measuring diaphragm can be stored directly at same and the evaluation device can externally retrieve the different calibrations. In that way the same evaluation device can always be installed for different models, design ranges and/or assembly sizes while the corresponding calibration operations can be retrieved from the respective diaphragm.

Protection is further sought for an injection assembly having a measuring arrangement according to the invention.

It can be provided that the measuring arrangement is arranged between the plasticising screw and the drive of the injection assembly.

Protection is further sought for a shaping machine having an injection assembly according to the invention. The term shaping machines is used to denote injection moulding machines, injection presses, presses and the like.

In regard to the method, the object of the invention is attained by a measuring arrangement according to the invention is provided and the first calibration or the at least one second calibration is selected in dependence on forces to be measured by means of the measuring arrangement.

In regard to the computer program product, the object is attained by the provision of commands which upon execution of the program by a computer cause it:
to receive an input signal in relation to the force range, and
to send an output signal to the measuring arrangement as described above, whereby the first calibration (k₁) or the at least one second calibration (k₂ . . . kₙ) is selected.

### BRIEF DESCRIPTION OF THE DRAWINGS

Further advantages and details of the invention will be apparent from the Figures and the accompanying specific description. In the Figures:

FIG. 1 shows an embodiment of a measuring arrangement according to the invention,

FIG. 2 shows an embodiment of a measuring arrangement according to the invention in an injection moulding machine, and

FIG. 3 is a flow chart showing the procedure when using an embodiment of a measuring arrangement according to the invention in an injection moulding machine.

### DETAILED DESCRIPTION OF THE INVENTION

FIG. 1 shows an embodiment of a measuring arrangement 6 according to the invention. It has a measuring diaphragm 1 which is deformable by a force action.

Mounted on the measuring diaphragm 1 is a measuring device 2 for metrological detection of a deformation of the measuring diaphragm 1, with the output of a measurement signal 7. Preferably the measuring device 2 is a strain gauge.

The deformation detected by the measuring device 2 is passed to an evaluation device 3, in the form of a measurement signal 7. The evaluation device 3 is adapted in the course of a first calibration operation k₁ to convert the measurement signal 7 originating from the deformation of the measuring diaphragm 1 with a force from a first force value range into a first output signal 8, the first output signal 8 being in a previously defined range of values.

In that arrangement the evaluation device 3 is adapted in the course of at least one second calibration operation k₂ to convert the measurement signal 7 originating from the deformation of the measuring diaphragm 1 with a force from a second force value range different from the first force value range, into a second output signal 8, the second output signal 8 being in the previously defined value range.

In that way different force value ranges can be mapped to the same output value range. Preferably calibrations k₁, k₂, . . . kₙ which map the lower limit of a force value range to the lower limit of the previously defined output value range and the upper limit of a force value range to the upper limit of the previously defined output value range and to cover the previously defined output value range completely by the output values of the force value range, Particularly preferably the lower limit of the output value range is 0 volt while the upper limit of the output value range is 10 volts.

The measurement signal 7 moves in a much smaller range than the output signal 8. Preferably the measuring device 2 delivers a measurement signal 7 in the millivolt range while the output value range moves in the order of magnitude of volts.

To convert the measurement signal 7 into the output value signal 8 the evaluation unit 3 includes an amplifier 4. So that the evaluation device in the course of at least two calibrations k₁, k₂, . . . kₙ can convert the measurement signal 7 originating from the deformation of the measuring diaphragm 1 with a force from different force value ranges into an output signal 8, wherein the output signal 8 is in the previously defined value range, it is necessary that the amplifier can amplify the measurement signal 7 by different amplification factors.

It can be seen from FIG. 1 that the amplifier unit can have any number of calibrations k₁, k₂, . . . kₙ, wherein according to the invention however there must be at least two calibrations k₁, k₂, . . . kₙ.

The evaluation device 3 is adapted to switch over between the at least two calibrations k₁, k₂, . . . kₙ.

In FIG. 1 a change is made between the at least two calibrations k₁, k₂, . . . kₙ by the amplification factor of the amplifier being altered. That is effected by the evaluation device 3 in accordance with a signal from the control means 4.

Preferably when there is no force acting on the measuring diaphragm 1 the measuring unit 2 delivers a measurement signal of zero volt. The greater the force acting on the measuring diaphragm 1 the correspondingly greater is the measurement signal 7, in which respect however it is always in the millivolt range. The force value range in which the loadings of the measuring arrangement 6 move are already known prior to measurement, in that way it is possible to select a suitable amplification factor for the amplifier and thus a corresponding calibration k₁, k₂, . . . kₙ in order to cover the known output value range as fully as possible.

Selection of a calibration k₁, k₂, . . . kₙ of the evaluation device 3 is effected by way of a signal from the control means 4 to the evaluation device 3. In that way the measuring arrangement 6 can be directly set to the corresponding force value range and the appropriate calibration k₁, k₂, . . . kₙ can be selected.

By virtue of the possibility of changing the calibration k₁, k₂, . . . kₙ by a control means 4 it is possible for the measuring arrangement 6, upon a change in the force value range to be expected, to be adapted directly to the altered loading on the measuring diaphragm 1 and thereby to always make the best possible use of the predetermined output value range. In that way, in the case of an injection assembly different force value ranges can be covered with one measuring arrangement by virtue of the calibrations k₁, k₂, . . . kₙ. That makes it possible to use different materials and/or vary the injection force.

Utilising the output value range has the result that, for all calibrations k₁, k₂, . . . kₙ which are not designed for the maximum loading on the measuring diaphragm 1, better resolution of the output signal 8 is available than in the case of a measurement operation with the calibration which is designed for the maximum loading.

The possibility of having various calibrations k₁, k₂, . . . kₙ available in the evaluation unit 3 also makes it possible to set the measuring arrangement 6 for force actions of varying magnitude and thus also for different machine types and/or assembly sizes.

The measuring arrangement 6 shown in FIG. 1 has a dedicated control means 4 and in this structure can be integrated into a shaping machine.

FIG. 2 shows a measuring arrangement 6 which is already integrated into an injection moulding machine. In this embodiment the evaluation device 3 of the measuring arrangement 6 is connected directly to the injection moulding machine control means 5.

In an injection moulding machine a measuring arrangement 6 according to the invention can be arranged between the plasticising screw and the drive of the injection assembly.

The measuring diaphragm 1 is deformed by a force action. The force which is acting can be determined by measurement of that deformation. In that respect deformation of the measuring diaphragm 1 is implemented with a measuring unit 2. Preferably the measuring unit 2 is a strain gauge.

The measuring unit 2 is connected with a signal line to the evaluation device 3. The evaluation device converts the measurement signal 7 communicated by the measuring unit 2 into the corresponding output signal 8.

Before a measurement operation or a measurement series is started one of the at least two calibrations k₁, k₂, . . . kₙ has to be selected for the evaluation device 3.

In the FIG. 2 embodiment the output signal 8 is communicated directly to the injection moulding machine control means 5 by way of a signal line. The control means 5 is thus connected directly to the measuring arrangement 6 and there is no need for an additional component to be arranged between the evaluation device 3 and the injection moulding machine control means 5.

Depending on the operating mode or the machine model the corresponding calibration k₁, k₂, . . . kₙ of the evaluation device 3 can be selected for the loading to be expected, by way of the injection moulding machine control means 5.

In that case selection of the calibration k₁, k₂, . . . kₙ is effected by communicating control pulses from the injection moulding machine control means 5 to the evaluation device 3. Selection of the calibration k₁, k₂, . . . kₙ by control pulses is in that case not limited to the injection moulding machine control means 5, but can also be effected in that way with a dedicated control means 4 of the measuring arrangement 6.

In the illustrated embodiment the evaluation device 3 has an integrated amplifier for converting the measurement signal 7 in connection with a suitable calibration k₁, k₂, . . . kₙ into the evaluation signal 8. Upon a change between the calibrations, the amplification factor of the amplifier is altered in that case.

By virtue of the different available calibrations k₁, k₂, . . . kₙ in the evaluation device 3 it is possible for the measuring arrangement 6 which is installed in a shaping machine to be subsequently calibrated. It is sufficient if the appropriate calibration k₁, k₂, . . . kₙ can be retrieved from the evaluation device 3.

The evaluation device has various calibrations k₁, k₂, . . . kₙ which correspond to different force value ranges. In that way, in the production of injection moulding machines with different assembly sizes and/or different demands on the force value range, the same measuring arrangement 6 can be fitted without previously selecting the calibration k₁, k₂, . . . kₙ.

Upon the first start-up of the injection moulding machine the desired calibration k₁, k₂, . . . kₙ can be selected directly or indirectly by the injection moulding machine control means.

FIG. 3 shows the flow chart of an embodiment of the computer program product according to the invention. In this case it is integrated into the control means of the injection moulding machine. The procedure for selection of a calibration k₁, k₂, . . . kₙ however does not change in that case.

In step a the injection moulding machine control means 5 checks the required measurement range. That depends on various factors, in particular the assembly size.

If the measurement range to be set is recognised the injection moulding machine control means 5 in step b passes the measurement range to be set to the evaluation device 3 of the measuring arrangement 6. In that respect the individual components can be in analog or digital communication with each other.

In step c the evaluation device 3 checks the communicated measurement range and matches it with the available calibrations k₁, k₂, . . . kₙ.

If the evaluation device 3 receives an invalid signal or if a measurement range is selected for which no calibration k₁, k₂, . . . kₙ can be provided then the flow chart follows path j and in step g an error message is communicated to the injection moulding machine control means 5. Due to the error message the operation is aborted and/or a corresponding error message is output by the injection moulding machine control means.

If the desired calibration k₁, k₂, . . . kₙ can be provided by the evaluation device then the flow chart follows path i and in step d the desired calibration k₁, k₂, . . . kₙ of the evaluation device is set.

When the desired calibration k₁, k₂, . . . kₙ is set then the evaluation device in step e sends a confirmation to the injection moulding machine control means that the calibration k₁, k₂, . . . kₙ was successfully set.

In step f the configuration of the calibration k₁, k₂, . . . kₙ to the required measurement range is completed and the injection moulding machine is ready to begin with production.

### LIST OF REFERENCES

1 measuring diaphragm
2 measuring device
3 evaluation device
4 control means
5 injection moulding machine control means
6 measuring arrangement
7 measurement signal
8 output signal
k₁ calibration 1
k₂ calibration 2
kₙ calibration n

1. A measuring arrangement for a shaping machine comprising
a measuring diaphragm which is deformable by a force action,
a measuring device for metrological detection of a deformation of the measuring diaphragm with the output of a measurement signal, and
an evaluation device connected to the measuring device,
which evaluation device is adapted in the course of a first calibration to convert the measurement signal originating from the deformation of the measuring diaphragm with a force from a first force value range into a first output signal, wherein the first output signal is in a previously defined value range,
wherein the evaluation device is adapted in the course of at least one second calibration to convert the measurement signal originating from the deformation of the measuring diaphragm with a force from a second force value range differing from the first force value range into a second output signal, wherein the second output signal is in the previously defined value range.

2. The measuring arrangement according to claim 1, wherein calibration of the evaluation device is adapted to map the lower limit of a force value range to the lower limit of the previously defined output value range and the upper limit of a force value range to the upper limit of the previously defined output value range and the previously defined output value range is completely covered by the output values of the force value range.

3. The measuring arrangement according to claim 1, wherein the evaluation device includes an amplifier adapted to amplify the signal by different amplification factors.

4. The measuring arrangement according to claim 1, wherein the evaluation device is adapted to switch over between the at least two calibrations.

5. The measuring arrangement according to claim 3, wherein the evaluation device is adapted to alter the amplification factor of the amplifier upon switching over between the at least two calibrations.

6. The measuring arrangement according to claim 4, wherein the evaluation device is adapted to control switching-over between the at least two calibrations by a signal of a central machine control means of a shaping machine.

7. The measuring arrangement according to claim 4, wherein the evaluation device is adapted to select the desired calibration by external control pulses, wherein the external control pulses differ by their time extent.

8. The measuring arrangement according to claim 1, wherein the data transmission between the individual components is analog or digital.

9. The measuring arrangement according to claim 1, wherein the evaluation device has more than two calibrations.

10. The measuring arrangement according to claim 1, wherein the evaluation device has an external memory which is arranged at the measuring diaphragm and on which the at least two calibrations are stored.

11. An injection assembly with the measuring arrangement according to claim 1.

12. The injection assembly according to claim 11, wherein the measuring arrangement is arranged between the screw and the drive of the injection assembly.

13. A shaping machine comprising the injection assembly according to claim 11.

14. A method of providing a calibration for a measuring arrangement, wherein the measuring arrangement according to claim 1 is provided and the first calibration or the at least one second calibration is selected in dependence on forces to be measured by means of the measuring arrangement.

15. A computer program product including commands which upon execution of the program by a computer cause it:
to receive an input signal in relation to the force range, and
to send an output signal to the measuring arrangement according to claim 1 whereby the first calibration or the at least one second calibration is selected.
